(19) United States
(12) Patent Application Publication
(10) Pub. No.: US 2006/0071595 A1
(43) Pub. Date: Apr. 6, 2006

(54) Plasma display panel

(76) Inventors: Seok-Gyun Woo, Suwon-si (KR); Hyun Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/244,962

(22) Filed: Oct. 6, 2005

(30) Foreign Application Priority Data
Oct. 6, 2004 (KR) 10-2004-0079489

(51) Int. Cl. H01J 17/49

(52) U.S. Cl. 313/584

(57) ABSTRACT

A plasma display panel with improved brightness and luminous efficiency is disclosed. The plasma display panel according to one embodiment comprises a rear substrate, a front substrate offset from the rear substrate, barrier ribs disposed between the front substrate and the rear substrate, discharge cells partitioned by the barrier ribs, discharge electrode pairs extending in a first direction across the discharge cells, address electrodes that extend across the discharge cells in a second direction that intersects the first direction, phosphor layers disposed in the discharge cells, and discharge gas is present within the discharge cells. In some embodiments, the discharge electrode pairs comprise a pair of bus electrodes that extend across the discharge cells and a pair of transparent electrodes, wherein one end of each of the transparent electrodes is connected to one of the pair of the bus electrodes and the other end of each of the transparent electrodes extends in a direction away from the center of each of the discharge cells.

### CROSS-REFERENCE TO RELATED APPLICATIONS

This application claims priority to Korean Patent Application No. 10-2004-0079489, filed on Oct. 6, 2004, in the Korean Intellectual Property Office, the disclosure of which is incorporated herein in its entirety by reference.

### BACKGROUND OF THE INVENTION

1. Technical Field

The present invention relates to a plasma display panel, and, more particularly, to a plasma display panel with improved brightness and luminous efficiency.

2. Discussion of Related Technologies

A conventional plasma display panel (“PDP”), which may be a substitute for a cathode-ray tube display, is a device in which discharge gas is introduced between two substrates. A discharge voltage introduced through a plurality of electrodes generates ultraviolet radiation, which excites phosphors with a predetermined pattern, thereby forming a desired image.

In a typical AC plasma display panel, the discharge electrodes 31 (31 for each) are disposed with respect to the discharge cells 80 as shown in FIG. 1. Referring to FIG. 1, each of the discharge electrodes 31 includes a transparent electrode 31a connected to a bus electrode 31b. The bus electrode 31b extends across a plurality of discharge cells 80 (80 for each). The transparent electrode 31a has a rectangular shape and is disposed on the bus electrode 31b as depicted in FIG. 1. One end of the transparent electrode 31a is connected to the bus electrode 31b and the other end of the transparent electrode 31a extends horizontally with a predetermined length toward the center of the discharge cell 80. The discharge electrodes 31 are arranged symmetrically with respect to the center of the discharge cells 80. See FIG. 1.

However, in the plasma display panel constructed as above, the bus electrodes 31b disposed on the discharge cells 80 are opaque, which reduces the aperture ratios of the discharge cells 80. Accordingly, visible light emitted from the discharge cells 80 is blocked, which reduces brightness and luminous efficiency of the PDP. For example, if bus electrodes with a width of about 50 μm are disposed in the discharge cells 80, brightness and luminous efficiency of a PDP are reduced by about 20%.

### SUMMARY OF CERTAIN INVENTIVE ASPECTS

One embodiment of the invention provides a PDP with improved brightness and luminous efficiency.

In one embodiment of the invention, a PDP comprises: a rear substrate that is offset from a front substrate. The PDP may further comprise a plurality of barrier ribs disposed between the front substrate and the rear substrate that define at least one discharge cell. The PDP may also be configured with a plurality of discharge electrode pairs that extend in a first direction, each including a pair of transparent electrodes and a pair of bus electrodes that extend across the discharge cells. Preferably, each transparent electrode is connected to a bus electrode and extends away from the center of a discharge cell. Some embodiments may also include address electrodes that extend across the discharge cells in a second direction that intersects the first direction. In some embodiments, at least one phosphor layer is disposed in the discharge cells, and discharge gas is present within the discharge cells.

In some embodiments, the distance between the pair of bus electrodes is between 30 μm and 80 μm .

In some embodiments of the invention, the width of each of the individual bus electrodes is between 30 μm and 100 μm. In other embodiments, the width of each individual bus electrode is between 30 μm and 130 μm.

In some embodiments, each bus electrode crosses each discharge cell near a center portion of each of the discharge cells. Preferably, there is a short-gap between the individual bus electrodes of each bus electrode pair that is formed over the discharge cells. In some of the embodiments of the invention, each of the transparent electrodes extends such that an end is located near the edge of a discharge cell.

In some embodiments, there are gaps between the discharge electrode pairs that are formed between the transparent electrodes of each discharge electrode pair.

In some embodiments of the invention, each transparent electrode is rectangular in shape. Preferably, the transparent electrodes are made of a transparent material.

In some embodiments, the invention further comprises a first dielectric layer that covers the discharge electrodes and a second dielectric layer that covers the address electrodes. In some embodiments, the discharge electrodes are disposed between the front substrate and first dielectric layer, and the address electrodes are disposed between the rear substrate and the second dielectric layer, and the barrier ribs are disposed between the first dielectric layer and the second dielectric layer.

In some embodiments, the PDP includes a structure in which the transparent electrodes are fed a discharge from the bus electrodes. Advantageously, this makes it possible to concentrate an electric field through the bus electrodes and efficiently generate discharge. In some embodiments, this configuration provides improved brightness and luminous efficiency and lowers the discharge firing voltage. A further benefit may be to reduce the discharge firing voltage required to discharge the bus electrodes and concentrate an electric field. Generally, this allows a discharge to be stably generated and a sustain discharge voltage margin can increase.

### BRIEF DESCRIPTION OF THE DRAWINGS

The above and/or other aspects of the invention will become more apparent by describing in detail exemplary embodiments of the invention with reference to the attached drawings in which:

FIG. 1 is a plan view showing discharge electrodes disposed with respect to discharge cells according to a conventional technique;

FIG. 2 is a cut-away exploded perspective view of a portion of a plasma display panel according to one embodiment of the invention; and

FIG. 3 is a plan view showing the discharge electrodes disposed with respect to the discharge cells of FIG. 2.

### DETAILED DESCRIPTION OF CERTAIN INVENTIVE EMBODIMENTS

Research is currently underway to develop a technique for disposing bus electrodes on barrier ribs. However, this causes the distance between a pair of bus electrodes to increase to a point that creates difficulty in discharging the voltage between bus electrodes. This will be described in detail as follows. In some embodiments, the thickness of a transparent electrode is generally between 0.1 μm and 0.15 μm and the thickness of a bus electrode is about 6 μm . The thickness of the bus electrode in these embodiments is about 60 times of that of the transparent electrode. In some embodiments, the area of bus electrodes is sufficiently large to be very important during discharge. Bus electrodes of larger area result in the loss of less current, a reduced voltage drop, and a strong and uniform electric field in the discharge cell. Furthermore, bus electrodes that are disposed far from the centers of discharge cells may cause a reduction in brightness and luminous efficiency. Bus electrodes arranged near the center of the discharge cells are closer to each other and therefore increase the strength of the electric field. However, this arrangement will block more visible rays. In some embodiments of the invention, the area and arrangement of the bus electrodes are designed to increase brightness and luminous efficiency.

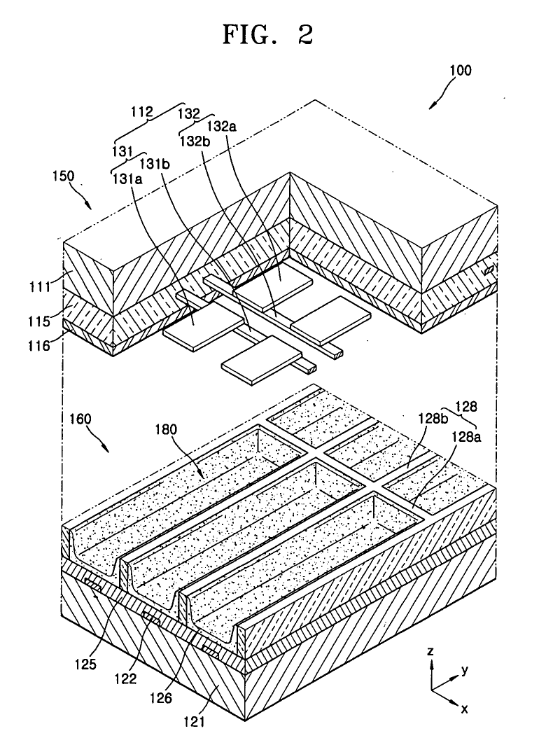

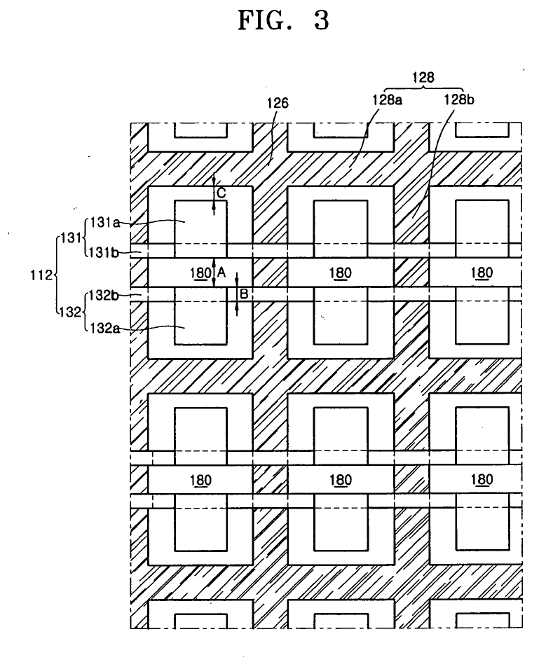

FIGS. 2 and 3 show a portion of a plasma display panel 100 according to one embodiment of the invention. FIG. 2 is a cut-away exploded perspective view of the plasma display panel 100 and FIG. 3 is a plan view of discharge cells 180 and discharge electrode pairs 112 shown in FIG. 2. For convenience in the following description, a direction (z direction) toward a front substrate 111 is referred to as the “front direction” and a direction (−z direction) toward a rear substrate 121 is referred to as the “rear direction”. Note that the front direction is the direction in which light is emitted from the PDP.

Referring to FIG. 2, some embodiments of the plasma display panel 100 include an upper plate 150 and a lower plate 160 that is fixed and parallel with respect to the upper plate 150. Generally, a plurality of discharge cells 180 (180 for each) are partitioned by barrier ribs 128 (128 for each) and disposed between a front substrate 111 included in the upper plate 150 and a rear substrate 121 included in the lower plate 160. In some embodiments, one objective of the barrier ribs 128 is to prevent electrical and optical cross-talk between the discharge cells 180. In some embodiments, the barrier ribs 128 include horizontal barrier ribs 128a (128a for each) arranged in the x direction (according to the coordinate references in FIG. 2) and vertical barrier ribs 128b (128b for each) orthogonally intersecting the horizontal barrier ribs 128a. Generally, a cross section of each discharge cell 180 that is parallel to the x-y plane is rectangular in shape. The barrier ribs 128 can be formed in various patterns. For example, the barrier ribs 128 may be formed in an open pattern such as a stripe pattern, a closed pattern such as a waffle pattern, a matrix pattern, a delta pattern, or any other suitable pattern as is now known or could be developed in the technology. Furthermore, the shape of the discharge cells in the x-y plane formed by barrier ribs that are in a closed pattern may be triangular, rectangular, pentagonal, circular, elliptical, or any other suitable shape.

Because in some embodiments visible light is emitted from the discharge cells 180 and transmitted through the front substrate 111, the front substrate 111 is preferably made of transparent material such as glass. The front substrate 111 generally has a thickness of several millimeters, although the thickness may vary according to the embodiment. In some embodiments, a plurality of electrode pairs 112 (112 for each pair) are located on the front substrate 150.

Preferably, each of the electrode pairs 112 includes a pair of discharge electrodes 131 and 132 (these electrodes are referred to herein as sustain electrode 131 and scan electrode 132), which are formed on the rear surface of the front substrate 111 to generate sustain discharge. In some embodiments, the discharge electrode pairs 112 are arranged in parallel at a predetermined distance from each other on the rear surface of the front substrate 111. It is contemplated that the electrode pairs 112 may be disposed in other locations. For example, the electrode pairs 112 can be disposed at a predetermined distance from the rear surface of the front substrate 111. In some embodiments, all of the electrode pairs 112 are disposed at a substantially equal distance from the rear surface of the front substrate 111.

In some embodiments of the invention, the sustain electrode 131 includes a transparent electrode 131a and a bus electrode 131b, and the scan electrode 132 includes a transparent electrode 132a and a bus electrode 132b. Preferably, the bus electrode 131b of the sustain electrode 131 and the bus electrode 132b of the scan electrode 132 extend in the x direction across the discharge cells 180 and are parallel and spaced by a predetermined distance with respect to each other. The bus electrodes 131b and 132b may be symmetrically offset from the center of the discharge cells 180 with respect to each other. In one embodiment, a distance A between bus electrodes 131b and 132b is between 30 μm and 80 μm. In some embodiments, the bus electrodes 131b and 132b are made of a metal material. In general, each of the bus electrodes 131b and 132b is formed with a relatively narrow width. The bus electrodes 131b and 132b may be formed from a single layer of the same material using a metal such as Ag, Al, or Cu. Alternatively, the bus electrodes 131b and 132b may be formed of a plurality of layers, each layer of a different material, such as Cr/Al/Cr.

In some embodiments of the invention, the transparent electrodes 131a and 132a are electrically connected to the bus electrodes 131b and 132b, respectively. Generally, the transparent electrodes 131a and 132a are made of transparent material that has a conductivity that allows discharge and transmittal of light emitted from phosphors 126 (126 for each) to the front substrate 111. For example, the transparent electrodes could be made of ITO (Indium Tin Oxide) in some embodiments. Although the invention is not bound by the theory, transparent conductive material, such as ITO, generally has high resistance. Accordingly, transparent electrodes composed of only transparent conductive material may cause high voltage drops in their longitudinal directions, which may require high driving power and reduce response speed. To help resolve these problems, some embodiments of the invention include narrow bus electrodes 131b and 132b made of metal that are connected to the transparent electrodes 131a and 132a.

In some embodiments, the thickness of each of the transparent electrodes 131a and 132a is between 0.1 μm and 0.15 μm. In one embodiment, the thickness of each of the bus electrodes 131b and 132b is about 6 μm. Therefore, in some embodiments, the bus electrodes 131b and 132b are about 60 times thicker than the transparent electrodes 131a and 132a. However, it is contemplated that the transparent electrodes 131a and 132a and bus electrodes 131b and 132b may be of different thickness than that specified above. In one preferred embodiment, the width B of each of the bus electrodes 131b and 132b is between 30 μm and 130 μm. More preferably, the width B of each of the bus electrodes 131b and 132b is between 30 μm and 100 μm. This will be described in detail below.

In some embodiments, the transparent electrodes 131a and 132a are rectangular in shape. Preferably, there is a plurality of transparent electrodes 131a and 132a that are discontinuously arranged with respect to the discharge cells 180. However, transparent electrodes 131a and 132a may be arranged in any other suitable manner. In some embodiments, the transparent electrodes 131a and 132a continuously extend across the discharge cells 180 like the bus electrodes 131b and 132b depicted in FIG. 3. In some embodiments, one end of each of the transparent electrodes 131a and 132a is electrically connected to one of the bus electrodes 131b and 132b, and the other end of each of the transparent electrodes 131a and 132a extends in a direction away from the center of a corresponding discharge cell 180. See FIG. 3.

In some embodiments, the transparent electrodes 131a and 132a extend toward the barrier rib 128a that forms an edge portion of the corresponding discharge cell 180. Referring to FIGS. 2 and 3, a distance C in the y-direction between an end of a transparent electrode 131a or 132a and a horizontal barrier rib 128a may be about 20 μm. It is contemplated that this distance may be more or less than 20 μ.

In some embodiments, the discharge electrodes 112 are arranged such that the thick bus electrodes 131b and 132b, as well as the transparent electrodes 131a and 132a with the wide electrode area, are disposed near the center of a discharge cell 180, which increases the area of electrodes above the discharge cell 180. Advantageously, this allows the plasma discharge to be more efficiently generated between the sustain electrode 131 and the scan electrode 132. This will be described in more detail later.

In some embodiments of the invention, a first dielectric layer 115 is formed on the back of the front substrate 111 such that it covers the discharge electrode pairs 112. Preferably, the first dielectric layer 115 is made of dielectric material, capable of preventing direct conduction between the adjacent sustain and scan electrodes 131 and 132. Although the invention is not bound to the theory, this may help prevent damage that may occur as a result of direct collision of positive ions or electrons with the sustain and scan electrodes 131 and 132, and attraction of wall charges. The dielectric material may include PbO, B₂O₃, Sio₂, or any other suitable dielectric materials.

In some embodiments of the invention, address electrodes 122 (122 for each) are arranged on the front surface of the rear substrate 121. Preferably, the address electrodes 122 extend across the discharge cells 180 in a direction that is parallel to the extension direction of the scan and sustain electrodes 131 and 132 with respect to each discharge cell 180.

In some embodiments, the address electrodes 122 generate address discharge to facilitate a sustain discharge between the X electrode 131 and the Y electrode 132, thus reducing the voltage required for the sustain discharge. Preferably, the address discharge occurs between the scan electrode 132 and the address electrode 122. After the address discharge is terminated, positive ions may accumulate near the scan electrode 132 and electrons may accumulate near the sustain electrode 131, which facilitates a sustain discharge between the sustain electrode 131 and the scan electrode 132.

A space formed by the pair of the sustain electrode 131 and scan electrode 132 and a corresponding address electrode 122 corresponds to a unit discharge cell 180.

In some embodiments, a second dielectric layer 125 is formed on the rear substrate 121 such that it covers the address electrodes 122. Preferably, the second dielectric layer 125 is made of a dielectric material capable of preventing damage that may result from direct collision of positive ions or electrons with the second dielectric layer 125 when discharge occurs, and attraction of wall charges. The dielectric material may comprise PbO, B₂O₃, SiO₂, or any other suitable dielectric materials.

Some embodiments may also comprise a protection layer 116 that is formed on the rear surface of the first dielectric layer 115. In general, the protection layer 116 helps prevent damage that may result from the direct collision of positive ions or electrons with the first dielectric layer 115 when discharge occurs. In some embodiments, the protection layer 116 has high optical transmittance properties and discharges a large amount of secondary electrons when discharge occurs. In some embodiments, the protection layer 116 is made of MgO, which may be formed as a thin film by sputtering or electron beam deposition, or by any other suitable method.

In some embodiments, phosphor layers 126, which may be red-emitting phosphor layers, green-emitting phosphor layers, and/or blue-emitting phosphor layers, are formed to cover the lateral sides of the barrier ribs 128 partitioning the discharge cells 180 and the exposed front surface of the second dielectric layer 125.

The phosphor layers 12 receive ultraviolet radiation that results from the plasma discharge and emit visible light. As an example, the red-emitting phosphor layers for red discharge cells include a component such as Y(V,P)O₄:Eu, the green-emitting phosphor layers for green discharge cells include a component such as Zn₂SiO₄:Mn, and the blue-emitting phosphor layers for blue discharge cells include a component such as BAM:Eu.

In some embodiments, a discharge gas may be present within the discharge cells 180. In one embodiment, the discharge gas comprises a mixture of Ne and Xe, but his mixture may be comprised other materials.

The following is a description of the operation of a plasma display panel 100 that comprises some or all of the above embodiments.

In some embodiments, plasma discharge generated in the plasma display panel 100 may be classified as address discharge or sustain discharge. Preferably, address discharge occurs when an address discharge voltage is applied between the address electrodes 122 and the scan electrodes 132, thereby selecting the discharge cells 180 to be sustain-discharged. Thereafter in some embodiments, if a sustain discharge voltage is applied between the sustain electrodes 131 and the scan electrodes 132 that correspond to the selected discharge cells 180, sustain discharge occurs in the discharge cells 180. Preferably, the sustain discharge voltage is applied to the bus electrodes 131b and 132b and transferred to the transparent electrodes 131a and 132a. Generally, a short-gap discharge is first generated between the adjacent bus electrodes 131b and 132b in the sustain electrode 131 and scan electrode 13 to which the sustain discharge voltage is applied. In some embodiments, after the short-gap discharge is generated, the discharge is diffused to the transparent electrodes 131a and 132a. Preferably, this reduces the discharge firing voltage required to discharge the bus electrodes 131b and 132b and concentrates an electric field. Therefore, even though some embodiments have a reduced electrode area of the bus electrodes 131b and 132b and/or the transparent electrodes 131a and 132a, discharge can be stably generated and a sustain discharge voltage margin can increase. In some embodiments, reducing the width B of each of the bus electrodes 131b and 132b improves an opening ratio above the discharge cells 180, which preferably contributes to further increase brightness and luminous efficiency.

In some embodiments of the invention, the short-gap discharge and the diffusion discharge are repeatedly and sequentially generated in the discharge cells 180. Preferably, while the sustain-discharge is performed, the energy level of an excited discharge gas lowers so that ultraviolet radiation is emitted. Preferably, the emitted ultraviolet radiation excites the phosphor layers 126 formed in the discharge cells 180. Accordingly, the energy level of the excited phosphor layers 126 decreases such that visible light is emitted. In some embodiments, the visible light is transmitted to the first dielectric layer 115 and the front substrate 111, thus forming an image to be recognized by a user.

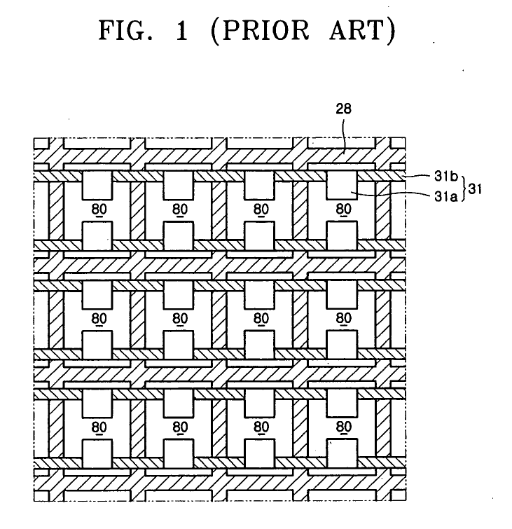

The results of an experiment that measured brightness and luminous efficiencies of a plasma display panel 100 according to one embodiment of the invention are compared to the same properties of a conventional plasma display panel (shown in FIG. 1) and shown in Table 1. The experiment's results were obtained by measuring brightness and luminous efficiency while changing the width B of a bus electrode. In Table 1, relative luminous efficiency E/D represents a relative ratio of luminous efficiency E of the plasma display panel according to one embodiment of the invention with respect to luminous efficiency D of a conventional plasma display panel when the luminous efficiency D is assumed to be 1.

Referring to Table 1, the brightness and luminous efficiency of a plasma display panel 100 constructed according to one embodiment of the invention are improved over a conventional PDP when the width B of a bus electrode is between 30 μM and 130 μm. In this embodiment, a bus electrode with a width B of 100 μm increases brightness about 4% and increases luminous efficiency about 14%. However, if the width B of the bus electrode is less than 30 μm, the bus electrodes may be difficult to manufacture, and increased resistance in the bus electrode may require the application of high voltages.

Therefore, it is preferable in certain embodiments that the width B of a bus electrode is between 30 μm and 100 μm.

TABLE 1

| | Width of bus | | Relative luminous |
|---|---|---|---|
| | electrode (μm) | Brightness (cd/m³) | efficiency (E/D) |
| Conventional | 100 | 164.0 | 1.00 |
| technique | | | |
| Present | 30 | 177.0 | 1.35 |
| invention | 40 | 177.3 | 1.32 |
| | 50 | 176.8 | 1.30 |
| | 60 | 176.2 | 1.29 |
| | 70 | 174.8 | 1.25 |
| | 80 | 172.7 | 1.20 |
| | 90 | 171.4 | 1.21 |
| | 100 | 170.3 | 1.14 |
| | 110 | 168.9 | 1.12 |
| | 120 | 167.5 | 1.09 |
| | 130 | 164.7 | 1.05 |
| | 140 | 163.7 | 1.00 |

As described above, one embodiment of the invention provides improved brightness and luminous effciency in PDPs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a rear substrate;
a front substrate offset from the rear substrate;
a plurality of barrier ribs disposed between the front substrate and the rear substrate wherein the barrier ribs define a plurality of discharge cells;
a plurality of discharge electrode pairs, each discharge electrode comprising a bus electrode extending across the discharge cells in a first direction, and at least one transparent electrode, wherein at least one end of the transparent electrode is connected to the bus electrode and the other end of the transparent electrode extends in a direction away from the center of a respective discharge cell;
a plurality of address electrodes that extend in a second direction across the discharge cells, wherein the second direction intersects the first direction;
at least one phosphor layer disposed within each discharge cell; and
a discharge gas present in the discharge cells.

2. The plasma display panel of claim 1, wherein a distance between each pair of bus electrodes is between 30 μm and 80 μm.

3. The plasma display panel of claim 1, wherein a width of each of the bus electrode pairs is between 30 μm and 130 μm.

4. The plasma display panel of claim 1, wherein a width of each of the bus electrode pairs is between 30 μm and 100 μm.

5. The plasma display panel of claim 1, wherein each of the bus electrode pairs has a minimum width near a center portion of each of the discharge cells.

6. The plasma display panel of claim 1, wherein there is a short gap in each bus electrode pair that is formed over each of the discharge cells.

7. The plasma display panel of claim 1, wherein each of the transparent electrodes extends such that a proximal end of each transparent electrode is located near an edge of each of the discharge cells.

8. The plasma display panel of claim 1, wherein each discharge electrode comprises a plurality of transparent electrodes, and the transparent electrodes are discontinuously arranged with respect to the discharge cells.

9. The plasma display panel of claim 8, wherein each of the transparent electrodes has a rectangular shape.

10. The plasma display panel of claim 1, wherein the transparent electrodes are formed from a transparent material.

11. The plasma display panel of claim 1, further comprising a first dielectric layer and a second dielectric layer, respectively, covering the discharge electrodes and the address electrodes.

12. The plasma display panel of claim 11, wherein the discharge electrodes are disposed between the front substrate and the first dielectric layer, the address electrodes are disposed between the rear substrate and the second dielectric layer, and the barrier ribs are disposed between the first dielectric layer and the second dielectric layer.

13. A plasma display panel comprising:
a rear substrate;
a front substrate offset from the rear substrate;
a plurality of barrier ribs disposed between the front substrate and the rear substrate wherein the barrier ribs define a plurality of discharge cells; and
a plurality of discharge electrode pairs, each discharge electrode comprising a bus electrode extending across the discharge cells in a first direction, and at least one transparent electrode, wherein at least one end of the transparent electrode is connected to the bus electrode and the other end of the transparent electrode extends in a direction away from the center of a respective discharge cell.
